(19) United States
(12) Patent Application Publication
(10) Pub. No.: US 2022/0296987 A1
(43) Pub. Date: Sep. 22, 2022

(54) ROTATING WHEEL AND BALANCE SCOOTER

(71) Applicant: E-LINK TECHNOLOGY CO., LTD, Shenzhen (CN)

(72) Inventor: Yufeng Chen, Shenzhen (CN)

(21) Appl. No.: 17/231,005

(22) Filed: Apr. 15, 2021

(30) Foreign Application Priority Data
Mar. 16, 2021 (CN) 202120544250.7

(51) Int. Cl. A63C 17/12; H02K 5/22; H02K 7/00; H02K 11/00; F21V 21/30; F21V 3/00; A63C 17/26; A63C 17/01; H04R 1/02; H04R 1/28; H04R 3/00

(52) U.S. Cl. CPC A63C 17/12; H02K 5/225; H02K 7/003; H02K 11/0094; F21V 21/30; F21V 3/00; A63C 17/26; A63C 17/011; H04R 1/028; H04R 1/2811; H04R 3/00; B62K 2202/00

(57) ABSTRACT

A rotating wheel and a balance scooter are provided. The rotating wheel includes a motor and an acoustic unit. The motor includes a stator, a rotor sleeved on a periphery of the stator and rotatable relative to the stator, and a motor shaft passing through the stator and defining a motor hole penetrating through the motor shaft. The motor hole is configured to receive a power wire and an audio wire. The acoustic unit is arranged on the motor shaft and electrically connected to the power wire and the audio wire.

### CROSS REFERENCE TO RELATED APPLICATIONS

This application claims priority to Chinese Patent Application No. 202120544250.7, filed opening on Mar. 16, 2021, the content of which is herein incorporated by reference in its entity.

### TECHNICAL FIELD

The present disclosure relates to the technical field of sports equipment, and in particular, to a rotating wheel and a balance scooter.

### BACKGROUND

Nowadays, balance scooters are more and more popular with young people, and the balance scooters are used for transportation or entertainment. The reason why the young people prefer the balance scooters is that, driving the balance scooters does not need to use both hands to control, and the movement of the balance scooters will be easily controlled by only using feet, which brings convenience to the young people and further make the young people feel cool. In the related art, balance scooters with functions of playing music have been developed. However, rotating wheels of the balance scooters having the functions of playing music are large in size, which make it difficult to achieve the miniaturization of the rotating wheels.

### SUMMARY

In one aspect, the present disclosure provides a rotating wheel. The rotating wheel includes a motor and an acoustic unit. The motor includes a stator, a rotor sleeved on a periphery of the stator and rotatable relative to the stator, and a motor shaft passing through the stator and defining a motor hole penetrating through the motor shaft. The motor hole is configured to receive a power wire and an audio wire. The acoustic unit is arranged on the motor shaft and electrically connected to the power wire and the audio wire.

In another aspect, a balance scooter may be further provided. The balance scooter may include a body and the rotating wheel as previously described. The rotating wheel may be connected to the body and configured to drive the body to move.

In a further aspect, a rotating wheel for a balanced scooter may be also provided. The rotating wheel may include a motor and an acoustic unit. The motor may include a stator; a rotor, sleeved on a periphery of the stator and rotatable relative to the stator; and a motor shaft, passing through the stator and defining a motor hole penetrating through the motor shaft, the motor hole being configured to receive a power wire and an audio wire. The acoustic unit may be disposed at one end of the motor shaft and outside the motor shaft. The power wire and the audio wire pass rough the motor hole and are further electrically connected to the acoustic unit.

### BRIEF DESCRIPTION OF THE DRAWINGS

In order to describe the technical solutions in the embodiments of the present disclosure more clearly, the following briefly introduces the accompanying drawings required for describing the embodiments. Apparently, the accompanying drawings in the following description are merely some embodiments of the present disclosure. For those skilled in the art, other drawings may be obtained based on these drawings without creative efforts.

FIG. 1 is a stereogram of a rotating wheel according to some embodiments of the present disclosure.

FIG. 2 is an exploded view of the rotating wheel shown in FIG. 1.

FIG. 3 is an exploded view of an acoustic unit shown in FIG. 2.

FIG. 4 is a stereogram of a motor shaft shown in FIG. 2.

FIG. 5 is a stereogram of a rotor shown in FIG, 2.

FIG. 6 is a cross-sectional view of the rotor shown in FIG, 5.

FIG. 7 is an exploded view of a lighting unit shown in FIG. 2.

FIG. 8 is a schematic view of a balance scooter according to some embodiments of the present disclosure.

In the figures:

100, rotating wheel; 10, motor; 12, stator; 14, rotor; 142, rotating member; 144, positioning plate; 145, clearance hole; 146, stator cavity; 148, light cavity; 20, acoustic unit; 21, first assembly hole; 22, rear shell; 222, wire hole; 23, front shell; 232, opening; 24, speaker; 30, lighting unit; 32, lighting circuit board; 34, lighting projection member; 36, lighting strip; 40, motor shaft; 41, second assembly hole; 42, motor hole; 50, power supply member; 60, back cover; 70, front cover; 80, tire; 91 power wire; 92 audio wire.

### DETAILED DESCRIPTION

The technical solutions in the embodiments of the present disclosure will be clearly and completely described in detail below with reference to the accompanying drawings in the embodiments of the present disclosure. Apparently, the embodiments described herein are only for description, not for limitation. In addition, it should be noted that, for convenience of description, only parts of configurations related to the present disclosure, rather than the complete configuration, are shown. Based on the embodiments described in the present disclosure, those skilled in the art may acquire all other embodiments without any creative efforts. All these shall be covered within the protection scope of the present disclosure.

“Embodiment” herein means that a particular feature, structure, or characteristic described with reference to embodiments may be included in at least one embodiment of the present disclosure. The term appearing in various places in the specification are not necessarily as shown in the same embodiment, and are not exclusive or alternative embodiments that are mutually exclusive with other embodiments. Those skilled in the art will understand explicitly and implicitly that the embodiments described herein may be combined with other embodiments.

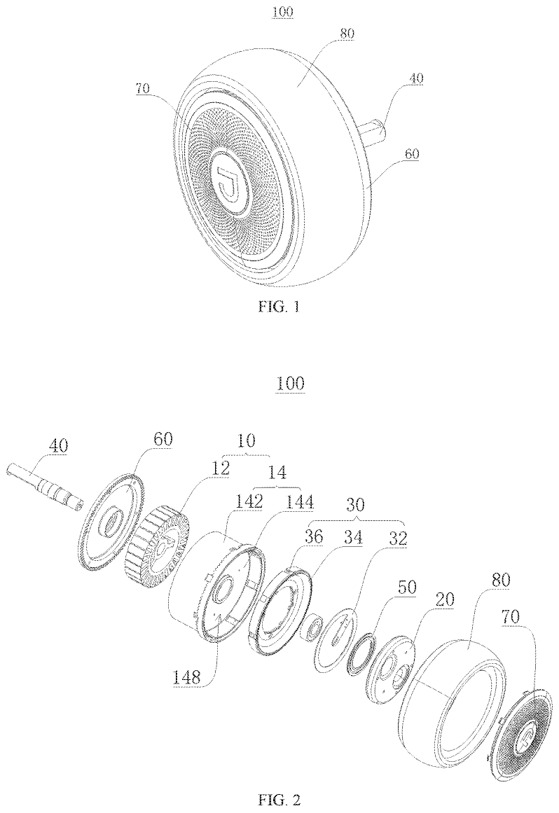

FIG. 1 is a stereogram of a rotating wheel according to some embodiments of the present disclosure, and FIG. 2 is an exploded view of the rotating wheel shown in FIG. I. As shown in FIGS. 1-2, in some embodiments, a rotating wheel 100 may be provided. The rotating wheel 100 may include a motor 10 and an audio unit 20. The motor 10 may include a stator 12, a rotor 14, and a motor shaft 40. In some embodiments, the motor shaft 40 may pass through the stator 12. In some embodiments, a through hole may be defined at a center of the stator 12, and the motor shaft 40 may pass through the through hole and be further inserted into the rotor 14. With reference to FIG. 4, a motor hole 42 passing through the motor shaft 40 may be defined in the motor shaft 40. The motor hole 42 may be configured to receive or accommodate a power wire 91 and an audio wire 92. The rotor 14 may be sleeved on a periphery of the stator 12, and may be rotatable relative to the stator 12. The audio unit 20 may be arranged on or even fixed on the motor shaft 40, and may be electrically connected to the power wire 91 and the audio wire 92. In this way, the audio unit 20 may be able to play music.

In some embodiments, the acoustic unit 20 may be disposed at one end of the motor shaft 40 and outside the motor shaft 40. The power wire 91 and the audio wire 92 may pass through the motor hole and may be further electrically connected to the acoustic unit 20.

More specifically, in some embodiments of the present disclosure, a power source and an audio source may be arranged outside the rotating wheel 100. One end of the power wire 91 may be electrically connected to the power source, and one end of the audio wire 92 may be electrically connected to the audio source. The other end of the power wire 91 and the other end of the audio wire 92 may each pass through the motor hole 42, extend out of the motor hole 42, and be further electrically connected to the audio unit 20. In this way, it is possible to supply power to the audio unit 20, and the audio unit 20 may produce a sound. By arranging the power wire 91 and the audio wire 92 in the motor hole 42, on one hand, the motor shaft 40 may provide a shielding to the power wire 91 and the audio wire 92 to reduce the possibility of damage to the power wire 91 and the audio wire 92 due to the exposure of the power wire 91 and the audio wire 92, and further reduce the possibility of affecting an appearance of the product. On the other hand, it may also possible to fully utilize the space inside the motor shaft 40 to make the structure of the rotating wheel 100 more compact. Furthermore, by arranging the power source and the audio source outside the rotating wheel, a volume of the rotating wheel 100 may be reduced.

In some embodiments, a mounting hole may be further defined in the center of the audio unit 20. The motor shaft 40 may be inserted in the mounting hole by an interference fit, such that the audio unit 20 may be fixed on the motor shaft 40. In this way, the mounting of the audio unit 20 may be simplified.

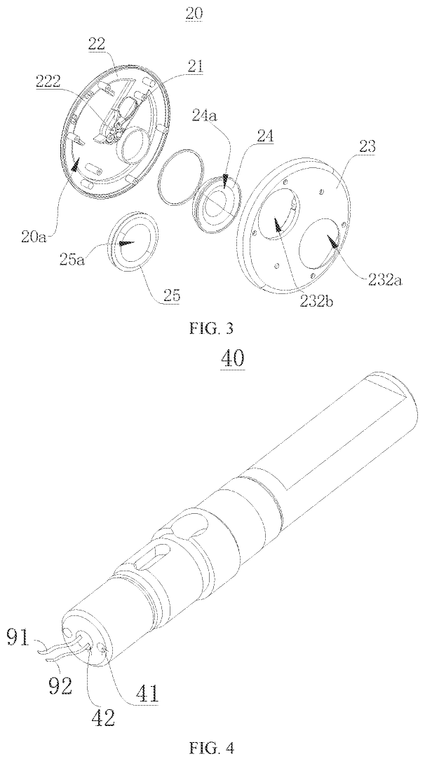

FIG. 3 is an exploded view of the acoustic unit 20 shown in FIG. 2, and FIG. 4 is a stereogram of the motor shaft 40 shown in FIG. 2, In some embodiments, as shown in FIG, 2 to FIG. 4, a first assembly hole 21 may be defined in the audio unit 20, and a second assembly hole 41 may be defined in the motor shall 40. A fastener such as a screw or the like may pass through the second assembly hole 21 and be further connected to (for example, inserted into) the second assembly hole 41. In this way, the audio unit 20 may be fixedly mounted at an end portion of the motor shaft 40. Or, in some embodiments, the motor shaft 40 and the audio unit 20 may also be fixedly connected to each other by, for example, bonding, which may be not specifically limited in the present disclosure.

Furthermore, as shown in FIG. 3, the audio unit 20 may include a rear shell 22, a front shell 23, a speaker 24, and a resonance unit 25. The rear shell 22 may be buckled with or engaged with the front shell 23 to form a receiving cavity 20a. The speaker 24 and the resonance unit 25 may be arranged or received in the receiving cavity 20a, and may be spaced apart from each other.

More specifically, one side of the rear shell 22 that is adjacent to the front shell 23 defines a first recess, and one side of the front shell 23 that is adjacent to the rear shell 22 defines a second recess, When the rear shell 22 is engaged with the front shell 23, the first recess and the second recess will cooperatively form or enclose or define the receiving cavity 20a configured to receive the speaker 24 and the resonance unit 25.

In some embodiments, it is possible to arrange a hook on one of the rear shell 22 and the front shell 23, and arrange a buckle on the other of the rear shell 22 and the front shell 23, and the rear shell 22 may be engaged with or buckled with the front shell 23 via the hook and the buckle. In some embodiments, each of the rear shell 22 and the front shell 23 may define an assembly hole, and the rear shell 22 and the front shell 23 may be fixedly connected to each other through the assembly holes defined in the rear shell 22 and the front shell 23 by using fasteners such as screws. In some embodiments, the rear shell 22 and the front shell 23 may also be connected to each other via threaded structures cooperating with each other, By connecting the rear shell 22 to the front shell 23 in a detachable manner, the mounting and maintenance of the audio unit 20 may be facilitated. By disposing the speaker 24 and the resonance unit 25 in the receiving cavity 20a, the structure of the audio unit 20 may be more compact. In this way, on one hand, the mounting of the audio unit 20 may be facilitated; on the other hand, the structure of the audio unit 20 may be compact, thereby reducing space occupied by the audio unit 20 in the rotating wheel 100. Thus, it is possible to realize the miniaturized design of the rotating wheel 100.

In addition, as shown in FIG. 3, the front shell 23 may define a first opening 232a at a position corresponding to the speaker 24, and further define a second opening 232b at a position corresponding to the resonance unit 25. The speaker 24 and the resonance unit 25 may be sandwiched between the front shell 23 and the rear shell 22. Furthermore, a sound output surface 24a of the speaker 24 may be arranged corresponding to the first opening 232a, and a sound output surface 25a of the resonance unit 25 may be arranged corresponding to the second opening 232b. Thus, by defining the first opening 232a in the front shell 23 at a position corresponding to the speaker 24 and the second opening 232b in the front shell 23 at a position corresponding to the resonance unit 25, it is possible to provide a clearance to the speaker 24 and the resonance unit 25. In this way, it is possible to reduce the possibility of reducing a volume due to the blocking of the sound from the speaker and the resonance unit 25 by the front shell 23.

In some embodiments of the present disclosure, the speaker 24 and the resonance unit 25 may be separately disposed at two sides of the front shell 23, and the speaker 24 and the resonance unit 25 may be spaced apart from each other. In this way, it is possible to reduce the possibility of reducing the structural strength of the front shell 23 due to the defining of the first opening 232a and the second opening 232b, the speaker 24 and the resonance unit 25 may produce sounds evenly, and the sound effect may be improved.

In some embodiments, as shown in FIGS. 3-4, the rear shell 22 is disposed at one side of the audio unit 20 that is adjacent to the motor shaft 40, that is, the rear shell 22 is disposed closer to the motor shaft 40 than the front shell 23. The connection between the motor shaft 40 and the audio unit 20 may be actually achieved by the connection between the motor shaft 40 and the rear shell 22 of the audio unit 20. The rear shell 22 may define a wire hole 222 corresponding to the motor hole 42. When the motor shaft 40 is connected to the rear shell 22, the motor hole 42 will be aligned with the wire hole 222. The power wire 91 and the audio wire 92 may pass through the motor hole 42 and the wire hole 222 and may be electrically connected to the speaker 24 and the resonance unit 25.

In some embodiments, as shown in FIG. 2, the rotating wheel 100 may further include a lighting unit 30. The lighting unit 30 may be arranged on the rotor 14 and electrically connected to the power source to emit light. The lighting unit 30 may be rotatable when driven by the rotor 14. On one hand, the lighting unit 30 may be configured for illumination. On the other hand, the lighting unit 30 may be further configured to form a cooling lighting effect to improve the visual appearance of the rotating wheel 100. In this way, the rotating wheel 100 in some embodiments of the present disclosure may integrate multiple functions, such that the functions of the rotating wheel 100 may be more diverse, and the user experience may be improved.

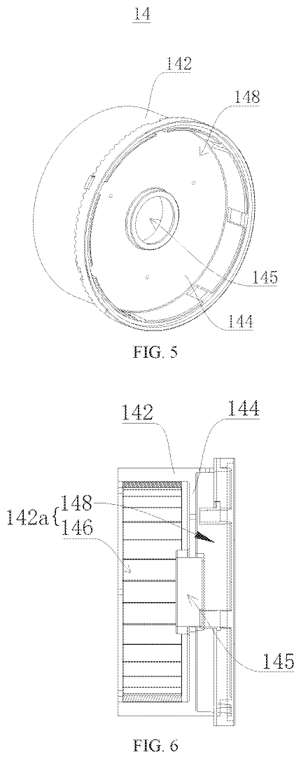

FIG. 5 is a stereogram of the rotor 14 shown in FIG. 2, and FIG. 6 is a cross-sectional view of the rotor 14 shown in FIG. 5. As further shown in FIGS. 5 and 6, the rotor 14 may include a rotating member 142 and a positioning plate 144 disposed in the rotating member 142. The rotating member 142 may be in shape of a barrel and implemented as a roller. The positioning plate 144 may be connected to an inner side wall of the rotating member 142 and divide an inner cavity 142a of the rotating member 142 into a stator cavity 146 and a light cavity 148. The stator 12 may be disposed in the stator cavity 146. The lighting unit 30 and the audio unit 20 may be disposed in the light cavity 148.

More specifically, a length of the rotating member 142 along an axial direction of the motor shaft 40 may be greater than a length of the stator 12 along the axial direction of the motor shaft 40. The positioning plate 144 may be disposed in the inner cavity 142a of the rotating member 142 and further connected to the inner side wall of the rotating member 142, such that the inner cavity 142a of the rotating member 142 may be divided into the stator cavity 146 and the light cavity 148 distributed along the axial direction of the motor shaft 40. A clearance hole 145 may be defined in the positioning plate 144. The stator 12 may be disposed in the stator cavity 146 and abut against the positioning plate 144, such that the stator 12 may be positioned by the positioning plate 144. The motor shaft 40 may pass through the center of the stator 12, protrude out of the clearance hole 145 defined in the positioning plate 144, and further extend to the light cavity 148. The audio unit 20 may be provided on a portion of the motor shaft 40 protruding out of the clearance hole 145. That is to say, the audio unit 20 and the lighting unit 30 may be disposed at a side of the positioning plate 144 opposite to the stator 12.

By arranging the positioning plate 144 in the rotating member 142 to separate the stator 12 from the acoustic unit 20 and the lighting unit 30, the sealing of the stator cavity 146 may be improved, and the possibility of damage to the stator 12 caused by external impurities entering the stator cavity 146 through the light cavity 148 may be reduced.

Furthermore, as shown in FIG. 2, the lighting unit 30 may be arranged between the audio unit 20 and the positioning plate 144. The rotating wheel 100 may include a power supply member 50 disposed between the audio unit 20 and the lighting unit 30. The power supply member 50 may be in shape of a ring, may be slidable, and may be configured to electrically connect the audio unit 20 to the lighting unit 30.

More specifically, the acoustic unit 20 may be electrically connected to the power source via the power line, and further electrically connected to the audio source via the audio wire 92. Since the power wire 91 and the audio wire 92 are arranged inside the motor shall 40, it may be inconvenient to electrically connect the power wire 91 and the audio wire 92 to the lighting unit 30. In addition, since the lighting unit 30 is arranged on the rotor 14 or even fixed on the rotor 14, during the rotation of the rotor 14, the power wire 91 and the audio wire 92 electrically connected to the lighting unit 30 will also he twined with each other, which may affect the rotation of the lighting unit 30.

Therefore, in some embodiments of the present disclosure, the power supply member 50 may be disposed between the audio unit 20 and the lighting unit 300, and the power supply member 50 may be electrically connected to the power line and the audio wire 92. In this way, when the lighting unit 30 is rotating along with the rotor 14, the lighting unit 30 may keep abutting against the power supply member 50. Thus, the lighting unit 30 may be electrically connected to the power wire 91 and audio wire 92 via the power supply member 50. Therefore, it is possible not only omit the power wire and the audio wire which are connected to the lighting unit 30 and reduce the twining of the power wire 91 and the audio wire 92 which affects the rotation of the lighting unit 30, but also simplify the electrical connection structure between the lighting unit 30 and the power wire 91 and between the lighting unit 30 and the audio wire 92. Furthermore, the mounting process of the lighting unit 30 may also he simplified to improve the production and assembly efficiency.

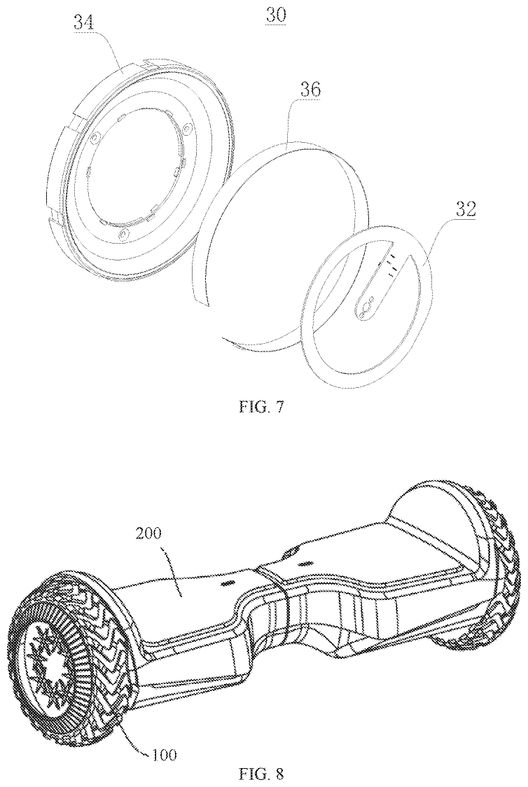

FIG. 7 is an exploded view of the lighting unit 30 shown in FIG. 2. As further shown in FIG. 7, the lighting unit 30 may include a lighting circuit board 32, a lighting projection member 34, and a lighting strip 36. The lighting circuit board 32 may be disposed between the audio unit 20 and the power supply member 50 and configured to electrically connect the audio unit 20 to the power supply member 50, The lighting projection member 34 may be substantially in shape of a plate or a disk, and may be disposed between the power supply member 50 and the positioning plate 144. The lighting projection member 34 may abut against the power supply member 50 and be further electrically connected to the power supply member 50. The lighting strip 36 may be sleeved on a periphery of the lighting projection member 34.

More specifically, the motor shaft 40 may pass through the lighting projection member 34. One side of the lighting projection member 34 may abut against the positioning plate 144, and the other side of the lighting projection member 34 may abut against the power supply member 50, such that the lighting projection member 34 may be electrically connected to the power wire 91 and the audio wire 92 via the power supply member 50. The lighting strip 36 may be substantially in shape of an annulus or a ring, and may be disposed around or surround the periphery of the lighting projection member 34. On one hand, the lighting projection member 34 may be configured to support the lighting strip 36,and light beads on the lighting strip 36 may be evenly spaced apart from each other along a circumferential direction of the rotary wheel 100. On the other hand, the lighting projection member 34 may be configured to electrically connect the lighting strip 36 to the power supply member 50, so as to supply power to the lighting strip 36.

In some embodiments, a control circuit may be arranged on the lighting circuit board 32. The lighting circuit board 32 may be electrically connected to the lighting projection member 34 and the lighting strip 36 arranged on the periphery of the lighting projection member 34 via the power supply member 50, and further control the lighting strip 36 to emit light, flicker, change color, or the like, to enhance the lighting effect of the lighting strip 36.

Furthermore, as shown in FIGS. 1 and 2, the rotating wheel 100 may include a back cover 60 and a face cover 70 disposed at two opposite sides of the rotating member 142. The back cover 60 may be connected to one side of the rotating member 142 and further cover the stator cavity 146, to reduce the possibility of damage to the motor 10 due to the external impurities entering the stator cavity 146. The face cover 70 may also be connected to the other side of the rotating member 142 and further cover the light cavity 148. The face cover 70 may be further configured to shield the audio unit 20 and the lighting unit 30, such that the appearance of the rotating wheel 100 may be more beautiful.

In some embodiments, as shown in FIGS. 1 and 2, the face cover 70 may be provided with a hollow portion, that is to say, a plurality- of through holes in same or different shapes may be defined in the face cover 70. The face cover 70 may be a light-transmitting component. More specifically, the hollow portion provided on the face cover 70 may facilitate the transmission of the sound of the audio unit 20 to obtain a larger volume. The -over 70 may be implemented as, for example, a light-transmitting component made of transparent plastic, such that the light emitted. from the lighting strip 36 may pass through the face cover 70 and further exit out of the face cover 70. In this way, it is possible to reduce the possibility of blocking the light emitted from the lighting strip 36. Thus, by providing the hollow portion on the face cover 70 and setting the face cover 70 as the light-transmitting component, the user experience may be improved.

Furthermore, as shown in FIGS. 1 and 2, the rotating wheel 100 may further include a tire 80. The tire 80 may be sleeved on a periphery of the rotor 14.

In some embodiments, the tire 80 may be a solid rubber tire, a hollow pneumatic tire, or the like. By sleeving the tire 80 on the periphery of the rotor 14, the tire 80 will be elastically deformed when being impacted. Thus, the damping effect of the rotating wheel 100 may be improved.

Further, in another aspect of the present disclosure, as shown in FIG. 8, a balance scooter may be further provided. The balance scooter may include a body 200 and a rotating wheel 100. The rotating wheel 100 may be connected to the body. The rotating wheel 100 may be configured to drive the body 200 to move or travel forward. The number of rotating wheels may be 1, 2, 3, or the like, which may be not limited here.

In some embodiments, the structure of the rotating wheel 100 may be the same as the structure of the rotating wheel 100 in the foregoing embodiments, may refer to the description in the foregoing embodiments, and will not be repeated here.

The above may be only implementations of the present disclosure, and do not limit the scope of the present disclosure. Any equivalent structure or equivalent process transformation made by using the content of the description and drawings of the present disclosure, or directly or indirectly applied to other related technical field may be similarly included in the scope of protection scope of the present disclosure.

What is claimed is:

1. A rotating wheel, comprising:
a motor, comprising:
a stator;
a rotor, sleeved on a periphery of the stator and rotatable relative to the stator; and
a motor shaft, passing through the stator and defining a motor hole penetrating through the motor shaft, the motor hole being configured to receive a power wire and an audio wire; and
an acoustic unit, arranged on the motor shaft, and electrically connected to the power wire and the audio wire.

2. The rotating wheel as claimed in claim 1, wherein the audio unit comprises a rear shell, a front shell, a speaker, and a resonance unit;
the rear shell is engaged with the front shell to cooperatively define a receiving cavity, and the speaker and the resonance unit are arranged in the receiving cavity.

3. The rotating wheel as claimed in claim 2, wherein the front cover defines a first opening at a position corresponding to the speaker and defines a second opening at a position corresponding to the resonance unit, the speaker and the resonance unit are sandwiched between the front shell and the rear shell, a. sound output surface of the speaker is arranged corresponding to the first opening, and a sound output surface of the resonance unit is arranged corresponding to the second opening.

4. The rotating wheel as claimed in claim 2, wherein the rear shell is disposed at one side of the audio unit that is adjacent to the motor shaft and connected to an end of the motor shaft, and a wire hole corresponding to the motor hole is defined in the rear shell;
the power wire and the audio wire pass through the motor hole and the wire hole, and are electrically connected to the speaker and the resonance unit.

5. The rotating wheel as claimed in claim 1, further comprising a lighting unit, wherein the lighting unit is disposed on the rotor and is rotatable when driven by the rotor.

6. The rotating wheel as claimed in claim 5, wherein the rotor comprises a rotating member and a positioning plate arranged in the rotating member, and the positioning plate divides an inner cavity of the rotating member into a stator cavity and a light cavity;
the stator is arranged in the stator cavity, and the lighting unit and the acoustic unit are arranged in the light cavity.

7. The rotating wheel as claim in claim 6, wherein a clearance hole is defined in the positioning plate;
the motor shaft passes through a center of the stator, protrudes out of the clearance hole define in the positioning plate, and further extends to the light cavity;
the audio unit is provided on a portion of the motor shall protruding out of the clearance hole.

8. The rotating wheel as claimed in claim 6, wherein the lighting unit is disposed between the acoustic unit and the positioning plate, the rotating wheel comprises a power supply member, and the power supply member is disposed between the acoustic unit and the lighting unit and configured to electrically connect the acoustic unit to the lighting unit.

9. The rotating wheel as claimed in claim 8, wherein the lighting unit comprises:
a lighting circuit board, arranged between the acoustic unit and the power supply member and configured to electrically connect the audio unit to the power supply member;
a lighting projection member, arranged between the power supply member and the positioning plate, abuts against the power supply member, and is further electrically connected to the power supply member; and
a lighting strip, sleeved on a periphery of the lighting projection member.

10. The rotating wheel as claimed in claim 9, wherein the motor shaft passes through the lighting projection member;
one side of the lighting projection member abuts against the positioning plate, and the other side of the lighting projection member abuts against the power supply member.

11. The rotating wheel as claimed in claim 6, further comprising:
a back cover, connected to one side of the rotating member and configured to cover the stator cavity; and
a face cover, connected to the other side of the rotating member opposite to the back cover and configured to cover the light cavity.

12. The rotating wheel as claimed in claim 11, wherein the face cover is provided with a hollow portion, and the face cover is a light-transmitting component.

13. The rotating wheel as claimed in claim 1, wherein the rotating wheel comprises a tire, and the tire is sleeved on a periphery of the rotor.

14. A balance scooter, comprising:
a body; and
a rotating wheel, connected to the body and configured to drive the body to move; wherein the rotating wheel comprises:
a motor, comprising:
a stator;
a rotor, sleeved on a periphery of the stator and rotatable relative to the stator; and
a motor shaft, passing through the stator and defining a motor hole penetrating through the motor shaft, the motor hole being configured to receive a power wire and an audio wire; and
an acoustic unit, arranged on the motor shaft and electrically connected to the power wire and the audio wire.

15. The balance scooter as claimed in claim 14, wherein the audio unit comprises a rear shell, a front shell, a speaker, and a resonance unit;
the rear shell is engaged with the front shell to cooperatively define a receiving cavity, and the speaker and the resonance unit are arranged in the receiving cavity.

16. The balance scooter as claimed in claim 15, wherein the front cover defines a first opening at a position corresponding to the speaker and defines a second opening at a position corresponding to the resonance unit, the speaker and the resonance unit are sandwiched between the front shell and the rear shell, a sound output surface of the speaker is arranged corresponding to the first opening, and a. sound output surface of the resonance unit is arranged corresponding to the second opening.

17. The balance scooter as claimed in claim 15. wherein the rear shell is disposed at one side of the audio unit that is adjacent to the motor shaft and connected to an end of the motor shaft, and a wire hole corresponding to the motor hole is defined in the rear shell;
the power wire and the audio wire pass through the motor hole and the wire hole, and are electrically connected to the speaker and the resonance unit.

18. The balance scooter as claimed in claim 14, further comprising a lighting unit, wherein the lighting unit is disposed on the rotor and is rotatable when driven by the rotor;
wherein the rotor comprises a rotating member and a positioning plate arranged in the rotating member, and the positioning plate divides an inner cavity of the rotating member into a stator cavity and a light cavity;
the stator is arranged in the stator cavity, and the lighting unit and the acoustic unit are arranged in the light cavity.

19. The balance scooter as claimed in claim 18, wherein a clearance hole is defined in the positioning plate;
the motor shaft passes through a center of the stator, protrudes out of the clearance hole define in the positioning plate, and further extends to the light cavity;
the audio unit is provided on a portion of the motor shaft protruding out of the clearance hole.

20. A rotating wheel for a balanced scooter, comprising:
a motor, comprising:
a stator;
a rotor, sleeved on a periphery of the stator and rotatable relative to the stator; and
a motor shaft, passing through the stator and defining a motor hole penetrating through the motor shaft, the motor hole being configured to receive a power wire and an audio wire; and
an acoustic unit, disposed at one end of the motor shaft and outside the motor shaft, wherein the power wire and the audio wire pass through the motor hole and are further electrically connected to the acoustic unit.
